(19) United States
(12) Patent Application Publication
(10) Pub. No.: US 2015/0116488 A1
(43) Pub. Date: Apr. 30, 2015

(54) Method for controlling a monitoring system and a system for its implementation

(71) Applicants: Ivan Sergeevich Shishalov, Nizhniy Novgorod (RU); Andrei Viktorovich Filimonov, s. Kamenki (RU); Oleg Andreevich Gromazin, Nizhnij Novgorod (RU); Sergei Vyacheslavovich Brunov, Balahna (RU)

(72) Inventors: Ivan Sergeevich Shishalov, Nizhniy Novgorod (RU); Andrei Viktorovich Filimonov, s. Kamenki (RU); Oleg Andreevich Gromazin, Nizhnij Novgorod (RU); Sergei Vyacheslavovich Brunov, Balahna (RU)

(21) Appl. No.: 14/407,469

(22) PCT Filed: Mar. 21, 2013
(86) PCT No.: PCT/RU2013/000201

§ 371 Date: Dec. 12, 2014

(30) Foreign Application Priority Data
Jun. 13, 2012 (RU) 2012124245

(51) Int. Cl. H04N 5/232; G06K 9/00; H04N 7/18

(52) U.S. Cl. CPC H04N 5/23203; H04N 7/18; G06K 9/00771; G06K 9/00657
USPC 348/143

(57) ABSTRACT

The invention relates to video surveillance systems. The method includes the following steps: first, the current information about the object is collected. A path is created for exploring the area by, at least, one means of surveillance, the path consisting of a set of points with fixed values of orientation of the surveillance means which are selected in such a way as to optimally explore all possible area according to technical performance of the surveillance means, terrain, height of the building and which define a set of monitoring plots, wherein the surveillance means monitors immovably each plot with a predetermined magnification value, Each of said plurality of plots is prioritized based on the priority list of the factors characterizing the probability of detection and fire occurrence, and according to which the parameters of the inspection path are defined, including the time needed for surveillance of each plot, the analysis algorithm of the resulting data. For high priority plots the inspection path parameters are chosen so that the probability of detecting an expected event, when analyzing the data obtained from surveillance, tends to the maximum, and the probability of false alarm is in the optimal range, depending directly on the probability of detecting an expected event, Following the change in the priority factors and/or environmental conditions, the priority is changed for each of a plurality of plots. The invention improves the reliability of event detection, reduces the probability of false responses, reduces the time required for detecting events and increases the accuracy of determining the coordinates of the object.

### FIELD OF INVENTION

The present invention relates generally to the field of video surveillance, and more particularly, to a method for controlling a system intended for monitoring the forest, which, in general, provides the ability to monitor large forest areas or areas with agricultural land for early detection of fires with the determination of their coordinates for further localization and extinguishing.

### BACKGROUND OF THE INVENTION

The forest fire video monitoring systems intended for the detection and location of forest fires are relatively new. However, their importance is ever growing, as the problem of forest fires can rightly be considered as one of the most serious and unresolved human problems at the moment. Forest fires occur and bring great damage in many countries of the world, as evidenced by wildfires in Russia in the summer of 2010, which had disastrous consequences, including also failure to comply with their early detection and their location, as has been many times discussed in detail in the media.

It should be noted that the performance of modern electronic hardware allows creating on their basis imaging and control devices among the components of the forest fire video monitoring system with a wide user functionality, which greatly simplifies the operator's work. In addition, modern hardware, with a special runtime software, can take over some of the functions for the automatic detection of potentially dangerous objects on video or still images, obtained from the cameras (when monitoring forests, such objects may be smoke, fire, etc.). Such systems of computer vision intended to find the image of dangerous objects can use a priori information about the features of smoke or fire, for example, specific movement, color, brightness, or other manifestations of fire, for example, they can detect the warm air from a fire, with a thermal imager, or with the gas analyzer they are able to detect emissions of certain gases. Similar systems of computer vision are used in many industries, ranging from robotics to security systems, which is described in detail, for example, in “Computer Vision: Modern Approach”, David Forsyth and Jean Ponce, Williams Publishing, 2004, p. 928. In this context, an intrinsic characteristic of automatic detection based on computer vision is the probability of false alarm and target missing that must be reduced by all means in each video monitoring system.

This intelligent subsystem (FIG. 1) using the specified computer vision technologies can be applied, depending on a particular embodiment, at the operator workstation 103, or on a server 104, or in the controlled video device itself 107.

Above is a generalized structural description of a typical modern forest fire video monitoring system, the principle of which is based on the use of controlled cameras. The given generalized description is not meant to be exhaustive and is intended to be a more user-friendly presentation of the invention, described in detail below.

The known examples of such forest fire video monitoring systems are the systems of ForestWatch (Canada), IPNAS (Croatia) and FireWatch (Germany). Similar systems have been developed in the Russian Federation (for example, “Kien” (Maple), “Baltika” (the Baltic), “Lesnoi Dosor” (Forest Watch).

It should be noted that the development and deployment of such forest fire video monitoring systems became possible only in the last few years. Only now, the number of cell phone towers is such that they cover the main fire risk areas, thereby minimizing infrastructure costs. In addition, broadband Internet services have also become much more affordable which allows exchanging large amounts of information over the Internet and transmitting real-time video, and the cost of equipment for wireless communication over long distances reduced. The processor performance, amount of memory and hard disk capacity has also increased, which allows the computer to intellectually handle large amounts of data in real time. It should be further noted that the detection of forest fires with cameras started in the late XX^{th}-early XXI^{st} century, but the systems proposed at the time, were primitive cameras with swivel function and the operator's screen, which was supposed to be in close proximity to the point of video monitoring. In practice, the proposed systems could not be scaled up and used for detecting fires even within a forest district, not to mention the area, region or the country.

### SUMMARY OF INVENTION

The specificity of the existing forest fire video monitoring systems is that it is impossible to cover the whole area around at one moment, as the cameras are controlled and they cover only a specific area at a time. The use of fixed cameras does not provide the ability to accurately determine the coordinates and besides, it limits the range of detection. Therefore, more time is needed to observe the entire territory. If we make shorter the periods of observation of each plot, the probability of detecting an expected event decreases, and if we make these periods longer, the efficiency of monitoring decreases, i.e. the time of detection increases, and the detection time for these systems is a very important parameter because it is an integral characteristic of the system, in the extreme case, if the observation in each point is infinitely long, the probability of detection will strive for 100%, but the time of detection will also tend to infinity.

In general, the monitoring systems 100 (FIG. 1) should have the following characteristics for the successful operation: 1. High reliability of detection (the probability of missing targets and the probability of false alarm should tend to the minimum). 2. Detection time should be minimal. 3. Accuracy of measuring an event coordinates should tend to the maximum. 4. Cost of installation and operation costs should be reduced.

Thus, the proposed invention is aimed at creating a relationship between the detection reliability and time of observation, in fact, the other characteristics are ignored, i.e. the reliability is maintained or increased for those plots where you need it, without serious degradation of observation time and the detection quality at other plots.

As a result of the proposed invention, the reliability of detection (detection probability) increases, the probability of false alarm, or false detection of an object decreases as well as the time needed for detection, inspection and analysis of information about the area 110 (FIG. 1).

It is provided by the present invention, which control method is implemented by the monitoring system (FIG. 2), comprising at least one remotely controlled monitoring point 102, containing an electronic surveillance means 107 with rotary and control devices arranged on a high-rise building 101, a means for determining the spatial orientation of the surveillance 107 means and a means for receiving and transmitting data, which includes the following steps:

201 first, the current information about the object under surveillance 105 is collected, and then 202 a path is created for exploring the area 110, at least by one means of surveillance 107, the path consisting of a set of points with fixed values of orientation of the surveillance means 107 which are selected in such a way as to optimally explore all possible area according to technical performance of the surveillance means 107, terrain, height of the building and zones of potential interest 110 and which 203 define a set of monitoring plots, wherein the surveillance means 107 monitors each plot at a given fixed surveillance angle
204 Then each of said plurality of plots is prioritized based on the priority list of the factors characterizing the probability of detection and fire occurrence, and according to which 205 the parameters of the inspection path 110 are defined, including the time needed for surveillance of each plot,
206 the analysis algorithm of the resulting data, and for high priority plots the inspection path parameters are chosen so that the probability of detecting an expected event, when analyzing the data obtained from surveillance 107, tends to the maximum, and the probability of false alarm is in the optimal range, depending directly on the probability of detecting an expected event,
207 while following the change in the priority factors and/or environmental conditions the priority is changed for each of a plurality of plots, in so doing, the surveillance path may remain unchanged, but some parameters of the points will change.

When implementing the method the following factors may be used as priority factors: a fire danger class due to weather conditions, the information on predicted weather events, a fire danger class of the area according to the type of trees, the information about the past and/or the impending storm, the information about the coordinates of lightning hit, the data on a fire received from other electronic surveillance means, horizontal visibility range at the plot under surveillance, probability of events recognition obtained from the electronic surveillance data, the information on the presence of people in the area under surveillance, and/or the presence of man-made objects, the information on the motorways and/or railroads passing through the object under surveillance, the information about fire statistics in the territory of the object, the information about the presence of fire already detected.

### DESCRIPTION OF DRAWINGS

These and other aspects of the present invention are disclosed in the following detailed description.

FIG. 1 schematically shows a part of the forest monitoring system,

FIG. 2 shows the block diagram of the method embodiment.

### DETAILED DESCRIPTION OF INVENTION

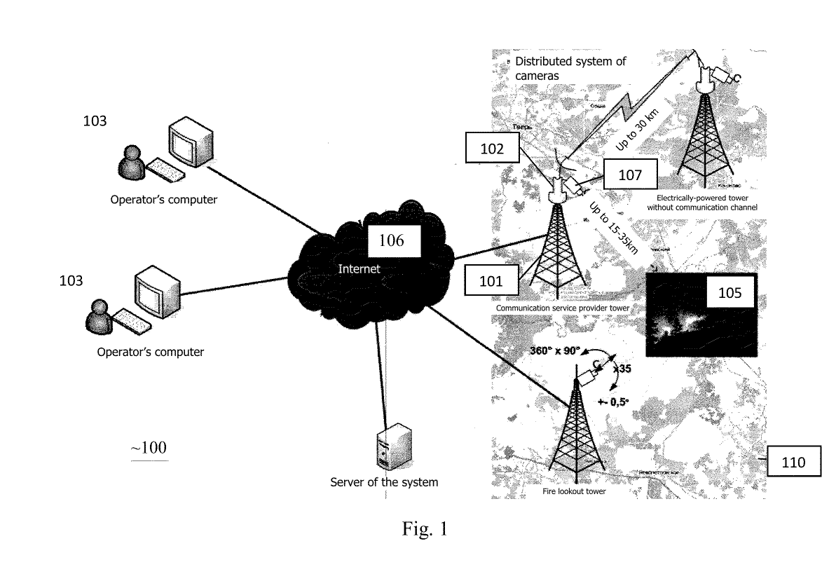

The present invention is implemented in all the embodiments using a system 100 (FIG. 1) consisting of at least one remote-controlled monitoring point 102, comprising an electronic surveillance means 107 with rotary and control devices arranged on a high-rise building 101, a means for determining the spatial orientation of the surveillance means and the equipment for receiving and transmitting data, wherein it comprises at least one computer-assisted operator workstation 103 and a computer-integrated module 104 configured to set a path for exploring the area by, at least, one means of surveillance, consisting of a set of points with fixed values of the orientation surveillance 107, the path consisting of a set of points with fixed values of orientation of the surveillance means based on the information about the object under surveillance obtained from a monitoring point 102, as well as the data on the priority factors, which may be obtained by any means: from the system itself, from external systems via digital channels or may be entered by users. The computer-integrated module is therewith adapted to implement computer vision-recognition algorithms on the data received from, at least, one electronic surveillance means and resulting from the observation of expected events.

Typically, a forest fire video monitoring system 100 (FIG. 1) consists of one or more remotely controlled video monitoring points 102 and one or more operator workstations 103 associated with them for the proper operation of video monitoring points.

The equipment of an operator workstation 103, in general, is based on well-known computer and communication technologies, and it typically contains a computer with special software and software for general use configured to remotely exchange data. The computer has a display device attached thereto that displays, when the computer is in operation, a graphical user interface (GUI) associated with a specialized application, by means of which the operator monitors visually the territory 110 and controls the monitoring points 102, and if an automatic computer vision system is available, the operator is able to validate the detected objects 105. The interaction with the elements of the graphical user interface is performed by means of well-known input devices connected to the computer, such as keyboard, mouse, etc.

Such an operator workstation 103 can be organized in a specialized center of control and monitoring. The presence of multiple workstations allows distributing the load among multiple operators to thereby enhance the quality of detection.

Each monitoring point 102 is substantially the transmitting side equipment arranged on a high-rise building.

The high-rise building 101, in general, can be any high-rise building, which meets the requirements imposed on the system (i.e. adapted to accommodate the transmitting side equipment at a sufficient height and configured to inspect large areas 110), and is usually a communication service provider tower, mobile operator tower, television tower, lighting tower, specialized fire lookout tower or the like.

Generally, the term “transmitting side equipment” denotes the equipment arranged on a high-rise building 101 containing an electronic surveillance means 107 with rotary and control devices, a means for determining the spatial orientation of the surveillance means and a means for receiving and transmitting data from the operator workstation.

The controlled electronic surveillance means 107 is generally a device that converts an optical range of electromagnetic waves, or a range, close to the optical range, into an electrical signal (such as a video camera, thermal imager, or their combination), this device being equipped with a zoom if possible, i.e. with an arrangement, which is designed for zooming in/out the obtained image and it is mounted on a rotating device by means of which one can mechanically change the spatial orientation of the tool with high precision.

The transmitting side equipment also contains a control unit, connected to a communication module, surveillance means 107, zoom, rotating device, and intended for the general control over the functions of the controlled device and its components in particular. In this manner, when receiving control signals from the operator or from the server system 104 through the communication module, the control unit is adapted to set the required spatial orientation of the surveillance means 107 (e.g., guiding it to the object 105 you want to observe, or to a path point), controlling the rotating device, and/or to perform zooming in/out of the picture of the object under surveillance, controlling the zoom. In addition, the control unit is adapted to determine the current spatial orientation of the surveillance means 107 and provide data on its current spatial orientation through the communication module to the requesting party (in particular, to the operator workstation 103, where the data, for example, are displayed in the graphical user interface).

Generally, the control device is microprocessor-based hardware unit of the controller or microcomputer type, etc., obvious to those skilled in the art, programmed in a manner known and/or programmed to perform the functions assigned to it. The programming of the control unit can be performed, for example, by writing (“flashing”) its microcode software (“firmware”), which is well known in the art. Accordingly, the device for controlling the surveillance means 107 is typically connected to a storage device (e.g. an integrated flash memory) which stores the related (microcode) software, the execution of which implements the functions associated with the control device.

The operator workstations 103 may be connected to the monitoring points 102, both directly and via a communication network 106 (e.g. network) using well-known and used wired and/or wireless, digital and/or analog communications technologies, and thus the communication module of the video monitoring point and the computer communication interface of the operator workstation should meet the communication standards/protocols for inducing such a link.

In this manner, the network 106 to which are connected the monitoring points 102 and operator workstations 103, can be an address network, such as the Internet. If the video monitoring point is near a communication channel belonging to an external provider, which is a common case, it is preferable to use this channel to connect the transmitting side equipment to the Internet. If the video monitoring point cannot be connected directly to the Internet, the well-known wireless broadband technologies (e.g. WiFi, WiMAX, 3G, etc.) are used for communication between the transmitting side equipment and the Internet access point. In a similar way, the operator workstations are connected to the network. For example, depending on the implemented access technology, modem (including wireless), network interface card (NIC), wireless access card, etc., which are external or internal in relation to the computer of the operator workstation, can be used for connecting to the network.

The system also preferably includes server 104 connected to a network, to which are delegated the centralized management functions of the totality of video monitoring points 102 and their interaction with the operator workstations 103 to ensure reliable system operation. The server 104 is usually a high-performance computer or a set of interconnected computers (for example, blade server bay) with specialized server software installed on it (them), having high speed (e.g. optical) connection to the Internet. The hardware/software implementation of such a server is obvious to those skilled in the art. In addition to the general system management functions, the server can perform a variety of highly specialized functions—for example, it can operate as a video server, providing intelligent intermediate data processing and sending them to the user upon request.

The said operator workstation 103 and server 104, operated electronic surveillance device 107 uses an intelligent subsystem of computer vision.

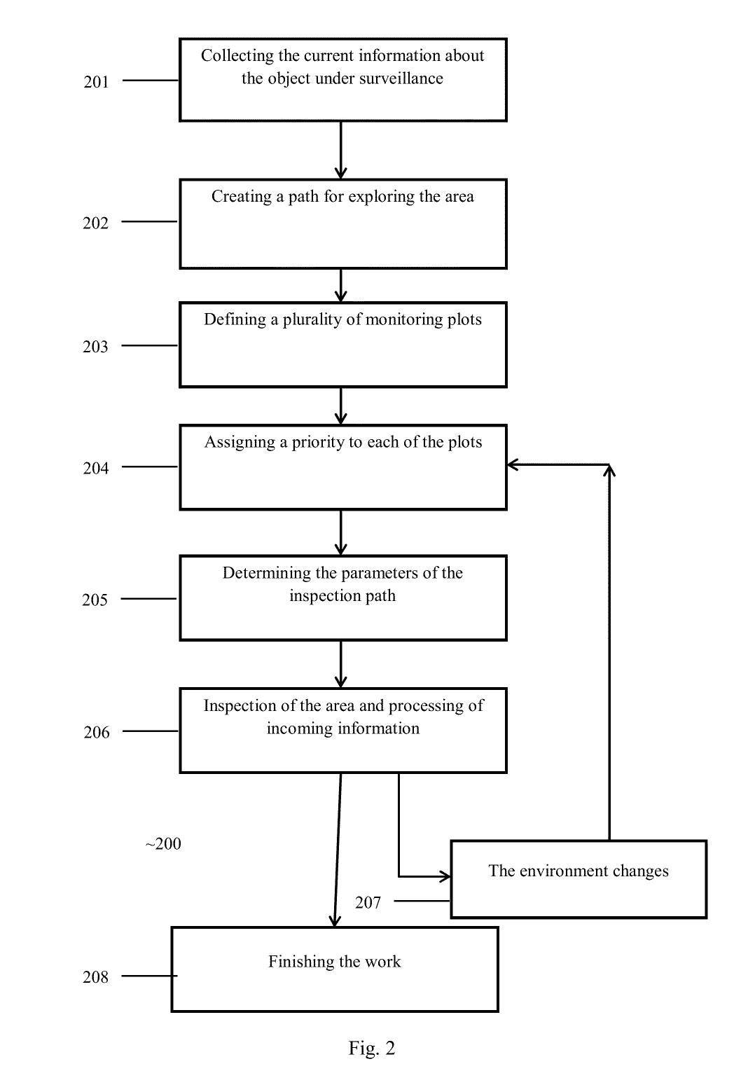

This system 200 is designed to search dangerous objects 105 in an image and can use a priori information about the features of smoke or fire, for example, specific movement, color, brightness, etc. In this context, an intrinsic characteristic of the automatic detection based on computer vision is the probability of false alarm and target missing that are minimized in this system 200 (FIG. 2) by means of the proposed method.

The operation of such algorithm should be based on the possibility of determining the exact current orientation of the electronic surveillance device 107.

The current location of the video camera can be determined quite accurately, for example, with the help of the modern global positioning system (GPS and/or GLONASS). As for the accuracy of the current orientation of the camera, it can also be quite high, which is provided by the modern rotary device (up to 0.1-0.05 degrees, such as in the case of controlled cameras manufactured by AXIS or PELCO), and this accuracy is growing with the development of technology.

To control the given monitoring system, the following method is used which comprises the steps as follows:

201 first, the current information about the object under surveillance 105 is collected and it may be both the information about the weather conditions and the information about the man-made objects, wherein the collection process can take place continuously during operation,
and then 202 a path is created for exploring the area 110, at least by one means of surveillance 107, the path consisting of a set of points with fixed values of orientation of the surveillance means 107 which are selected in such a way as to optimally explore all possible area according to technical performance of the surveillance means 107, terrain, height of the building and zones of potential interest 110
and which 203 define a set of monitoring plots, wherein the surveillance means 107 monitors each plot at a given fixed surveillance angle (if it is possible to zoom in, if it is not, then simply with a fixed orientation)
204 Then each of said plurality of plots is prioritized based on the priority list of the factors characterizing the probability of detection and fire occurrence, and
according to which 205 the parameters of the inspection path 110 are defined, including the time needed for surveillance of each plot,
206 the analysis algorithm of the resulting data, and for high priority plots the inspection path parameters are chosen so that the probability of detecting an expected event, when analyzing the data obtained from surveillance 107, tends to the maximum, and the probability of false alarm is in the optimal range, depending directly on the probability of detecting an expected event,
207 while following the change in the priority factors and/or environmental conditions the priority is changed for each of a plurality of plots, in so doing, the surveillance path may remain unchanged, but some parameters of the points will change.

The path can be formed on the computerized workstation 103 or, which is more preferably, automatically on the server 104, based on all data that came in 100, and goes to, at least, one means of surveillance, which, when performing the executive algorithm of the path, sends information to the operator workstation 103 or the server 104, so that the treatment can be carried out in any place where during the processing of incoming data 206 (FIG. 2), messages are reported on the presence of fire, smoke, and other events, the detection of which is programmed. If the environment changes, the visibility decreases, nights/days fall, fog or rain occurs, the operator or the system itself can automatically make adjustments to the specified path and continue to work, taking into account the changed situation. The automatic change of the path parameters by the system is the most preferred embodiment of the method.

When implementing the method 200 (FIG. 2) the following may be used as priority factors: a fire danger class due to weather conditions, the information on predicted weather events, a fire danger class of the area according to the type of trees, the information about the past and/or the impending storm, the information about the coordinates of lightning hit, the data on a fire received from other electronic surveillance means, horizontal visibility range at the plot under surveillance, probability of events recognition obtained from the electronic surveillance data, the information on the presence of people in the area under surveillance, and/or the presence of man-made objects, the information on the motorways and/or railroads passing through the object under surveillance, the information about fire statistics in the territory of the object, the information about the presence of fire already detected.

This information can be obtained using reference books, electronic surveillance means, or other sources possessing this information (for example, weather information resources, etc.)

The invention has been described above with reference to specific embodiments thereof. For those skilled in the art other embodiments of the invention can be obvious, which departing from the spirit thereof, as it is disclosed herein. Accordingly, the invention should be considered as limited in scope only by the following claims.

We claim:

1. A method for controlling a monitoring system comprising at least one remotely controlled monitoring point, containing an electronic surveillance means arranged on a high-rise building with rotary and control devices, a means for determining the spatial orientation of the surveillance means and a means for receiving and transmitting data, comprising the following steps: first, the current information about the object under surveillance is collected, and then a path is created for exploring the area, at least by one means of surveillance, the path consisting of a set of points with fixed values of orientation of the surveillance means which are selected in such a way as to optimally explore all possible areas according to technical performance of the surveillance means, terrain, height of the building and zones of potential interest and which define a set of monitoring plots, wherein the surveillance means monitors each plot at a given fixed surveillance angle, then each of said plurality of plots is prioritized based on the priority list of the factors characterizing the probability of detection and fire occurrence, and according to which the parameters of the inspection path are defined, including the time needed for surveillance of each plot, the analysis algorithm of the resulting data, and for high priority plots the inspection path parameters are chosen so that the probability of detecting an expected event, when analyzing the data obtained from surveillance, tends to the maximum, and the probability of false alarm is in the optimal range, depending directly on the probability of detecting an expected event, while following the change in the priority factors and/or environmental conditions the priority is changed for each of a plurality of plots.

2. The method as claimed in claim 1, wherein a fire danger class based on weather conditions is also used as a priority factor.

3. The method as claimed in claim 1, wherein the information on the projected weather events is also used as a priority factor.

4. The method as claimed in claim 1, wherein a fire danger class of the area based on the type of vegetation is also used as a priority factor.

5. The method as claimed in claim 1, wherein the information about the past and/or the impending storm is also used as a priority factor.

6. The method as claimed in claim 1, wherein the information about the coordinates of a lightning hit is also used as a priority factor.

7. The method as claimed in claim 1, wherein the data on the presence of fire, received from other electronic surveillance means, are also used as a priority factor.

8. The method as claimed in claim 1, wherein the horizontal visibility range at the monitoring plot is also used as a priority factor.

9. The method as claimed in claim 1, wherein the probability of recognizing an event derived from the electronic surveillance data is also used as a priority factor.

10. The method as claimed in claim 1, wherein the information on the presence of people in the area under surveillance and/or the presence of man-made objects is also used as a priority factor.

11. The method as claimed in claim 1, wherein the information on the motorways and/or railroads passing through the object under surveillance is also used as a priority factor.

12. The method as claimed in claim 1, wherein as priority factor also used the information about fire statistics on the area under surveillance.

13. The method as claimed in claim 1, wherein the information about the presence of fire already detected is also used as a priority factor.

14. The monitoring system for implementing the method according to claims 1 to 13, consisting of at least one remote-controlled monitoring point, comprising a
an electronic surveillance means arranged on a high-rise building with rotary and control devices, a means for determining the spatial orientation of the surveillance means and the equipment for receiving and transmitting data, which is characterized in that it comprises at least one computer-assisted operator workstation and a computer-integrated module configured to set a path for exploring the area by, at least, one means of surveillance, consisting of a set of points with fixed values of the orientation surveillance, the path consisting of a set of points with fixed values of orientation of the surveillance means based on the information about the object under surveillance obtained from a monitoring point, as well as the data on the priority factors, and adapted to implement computer vision-recognition algorithms on the data received from, at least, one electronic surveillance means and resulting from observation of expected events.
